(19) United States
(12) Patent Application Publication
(10) Pub. No.: US 2011/0227923 A1
(43) Pub. Date: Sep. 22, 2011

(54) IMAGE SYNTHESIS METHOD

(75) Inventors: Roberto Mariani, Singapore (SG); Richard Roussel, Singapore (SG); Manoranjan Devagnana, Singapore (SG)

(73) Assignee: XID TECHNOLOGIES PTE LTD, Singapore (SG)

(21) Appl. No.: 12/736,518

(22) PCT Filed: Apr. 14, 2008
(86) PCT No.: PCT/SG2008/000123

§ 371 Date: May 27, 2011

(51) Int. Cl. G06T 15/20

(52) U.S. Cl. 345/427

(57) ABSTRACT

With the ubiquity of new information technology and media, face and facial expression recognition technologies have been receiving significant attention. For face recognition systems, detecting the locations in two-dimension (2D) images where faces are present is a first step to be performed. However, face detection from a 2D image is a challenging task because of variability in imaging conditions, image orientation, pose, presence/absence of facial artefacts facial expression and occlusion. Existing efforts to address the shortcomings of existing face recognition systems involve technologies for creation of three-dimensional (3D) models of a human subject's face based on a digital photograph of the human subject. However, such technologies are computationally intensive nature and susceptible to errors and hence might not be suitable for deployment. An embodiment of the invention describes a method for synthesizing a plurality of 2D face images of an image object based on a synthesized 3D head object of the image object.

### FIELD OF INVENTION

The invention relates to image processing systems. More particularly, the invention relates to a method for synthesizing faces of image objects.

### BACKGROUND

With the ubiquity of new information technology and media, more effective and friendly human computer interaction (HCI) means that are not reliant on traditional devices, such as keyboards, mice, and displays, are being developed. In the last few years, face and facial expression recognition technologies have been receiving significant attention and many research demonstrations and commercial applications have been developed as a result. The reason for the increased interest is mainly due to the suitability of face and facial expression recognition technologies for a wide range of applications such as biometrics, information security, law enforcement and surveillance, smart cards and access control.

An initial step performed by a typical face recognition system is to detect locations in an image where faces are present. Although there are many other related problems of face detection such as face localization, facial feature detection, face identification, face authentication and facial expression recognition, face detection is still considered as one of the foremost problem to be tackled in respect of difficulty. Most existing face recognition systems typically employ a single two-dimension (2D) representation of the face of the human subject for inspection by the face recognition systems. However, face detection based on a 2D image is a challenging task because of variability in imaging conditions, image orientation, pose, presence or absence of facial artefacts, facial expression and occlusion.

In addition, existing face recognition systems are able to function satisfactorily only when both the training images and the actual image of the human subject to be inspected are captured under similar conditions. Furthermore, there is a requirement that training images captured under different conditions for each human subject are to be made available to the face recognition systems. However, this requirement is considered unrealistic since typically only a small number of training images are generally available for a human subject under deployment situations. Further efforts to address the shortcomings of existing face recognition systems deal with technologies for creation of three-dimensional (3D) models of a human subject's face based on a 2D digital photograph of the human subject. However, such technologies are inherently susceptible to errors since the computer is merely extrapolating a 3D model from a 2D photograph. In addition, such technologies are computationally intensive and hence might not be suitable for deployment in face recognition systems where speed and accuracy are essential for satisfactory performance.

Hence, in view of the foregoing problems, there affirms a need for a method for providing an improved means for performing face detection.

### SUMMARY

Embodiments of the invention disclosed herein provide a method for synthesizing a plurality of 2D face images of an image object based on a synthesized 3D head object of the image object.

In accordance with a first aspect of the invention, there is disclosed a method for synthesizing a representation of an image object. The method comprises providing an image of the image object in which the image is a two-dimensional (2D) representation of the image object. Further, the method comprises providing a three-dimensional (3D) mesh having a plurality of mesh reference points in which the plurality of mesh reference points are predefined. The method also comprises identifying a plurality of feature portions of the image object from the image and identifying a plurality of image reference points based on the plurality of feature portions of the image object. The plurality of image reference points has 3D coordinates. In addition, the method comprises at least one of manipulating and deforming the 3D mesh by compensating the plurality of mesh reference points accordingly towards the plurality of image reference points and mapping the image object onto the deformed 3D mesh to obtain a head object in which the head object is a 3D object. The synthesized image of the image object in at least one of an orientation and a position is obtainable from the head object positioned to the at least one of the orientation and the position.

In accordance with a second aspect of the invention, there is disclosed a device readable medium having stored therein a plurality of programming instructions, which when execute by a machine, the instructions cause the machine to provide an image of the image object in which the image is a two-dimensional (2D) representation of the image object. Further the instructions cause the machine to provide a three-dimensional (3D) mesh having a plurality of mesh reference points in which the plurality of mesh reference points are predefined. The instructions also cause the machine to identify a plurality of feature portions of the image object from the image and identify a plurality of image reference points based on the plurality of feature portions of the image object. The plurality of image reference points has 3D coordinates. In addition, the instructions cause the machine to at least one of manipulate and deform the 3D mesh by compensating the plurality of mesh reference points accordingly towards the plurality of image reference points and map the image object onto the deformed 3D mesh to obtain a head object in which the head object is a 3D object. The synthesized image of the image object in at least one of an orientation and a position is obtainable from the head object positioned to the at least one of the orientation and the position.

### BRIEF DESCRIPTION OF THE DRAWINGS

Embodiments of the invention are disclosed hereinafter with reference to the drawings, in which:

FIG. 1 is a two-dimensional (2D) image of a human subject to be inspected by a facial recognition system employing the face-synthesizing techniques provided in accordance with an embodiment of the present invention;

FIG. 2 is a generic three-dimensional (3D) mesh representation of the head of a human subject;

FIG. 3 shows the identification of feature portions of the 3D mesh of FIG. 2;

FIG. 4 is an image in which feature portions of the human subject of the image of FIG. 1 are identified;

FIG. 5 shows global and local deformations being applied to the 3D mesh of FIG. 3; and

FIG. 6 shows an image of a synthesized 3D head object of the human subject in the 2D image of FIG. 1.

### DETAILED DESCRIPTION

A method for synthesizing a plurality of 2D face images of an image object based on a synthesized 3D head object of the image object are described hereinafter for addressing the foregoing problems.

For purposes of brevity and clarity, the description of the invention is limited hereinafter to applications related to 2D face synthesis of image objects. This however does not preclude various embodiments of the invention from other applications of similar nature. The fundamental inventive principles of the embodiments of the invention are common throughout the various embodiments.

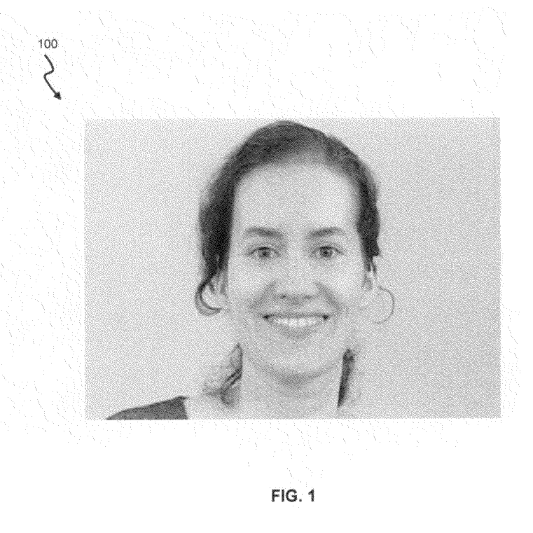

Exemplary embodiments of the invention described hereinafter are in accordance with FIGS. 1 to 6 of the drawings, in which like elements are numbered with like reference numerals.

FIG. 1 shows a two-dimensional (2D) image 100 representation of a human subject to be inspected using face recognition. The 2D image 100 preferably captures a frontal view of the face of the human subject in which the majority of the facial features of the human subject are clearly visible. The facial features include one or more of the eyes, the nose and the mouth of the human subject. By clearly showing the facial features of the human subject in the 2D image 100, the synthesizing of an accurate representation of a three-dimensional (3D) head object of the human subject can then be performed subsequently. In addition, the 2D image 100 is preferably acquired using a device installed with either a charge-coupled device (CCD) or a complementary metal-oxide-semiconductor (CMOS) sensor. Examples of the device include digital cameras, webcams and camcorders.

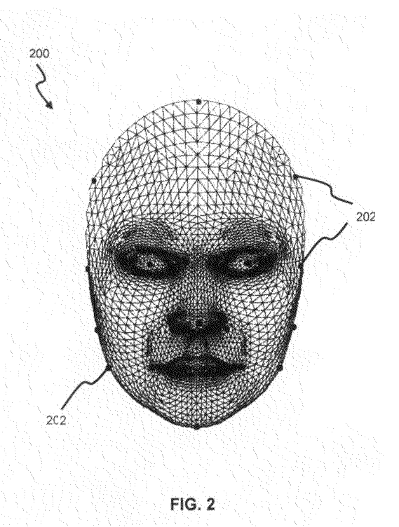

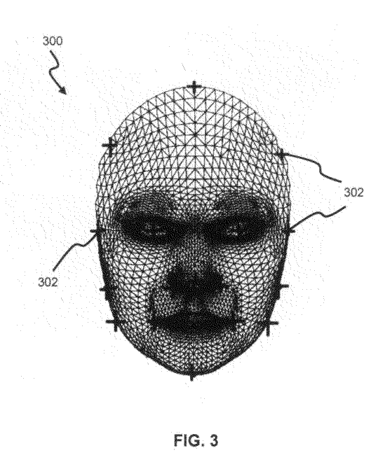

FIG. 2 shows a 3D mesh 200 representing the face of a human subject. The 3D mesh 200 is a generic face model constructed from sampled data obtained from faces of human subjects representing a cross-section of a population. The 3D mesh 200 comprises vertices tessellated for providing the 3D mesh 200. In addition, the 3D mesh 200 is provided with a plurality of predefined mesh reference points 202 in which the plurality of predefined mesh reference points 202 constitutes a portion of the vertices. The plurality of mesh reference points 202 comprises a first plurality of mesh reference points and a second plurality of mesh reference points. Preferably, the first plurality of mesh reference points comprises a portion of the vertices defining left and upper contour portions, and left and right lower contour portions of the face of the human subject. The first plurality of mesh reference points are adjustable for performing global deformation of the 3D mesh 200. Separately, the second plurality of mesh reference points comprises a portion of the vertices around key facial features such as on the left and right eye center, the left and right nose lobe, and the left and right lip ends. The second plurality of mesh reference points are also adjustable for performing local deformation of the 3D mesh 200. The markings 302 of the first plurality of mesh reference points and the second plurality of mesh reference points are as shown in FIG. 3. The 3D mesh 200 is then later adapted to the face of the human subject to be inspected using face recognition.

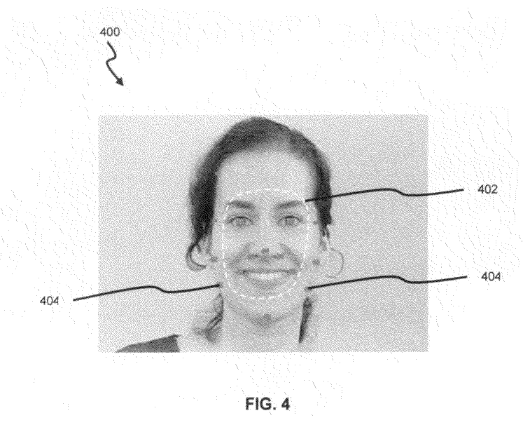

From the 2D image 100 of FIG. 1, a plurality of feature portions of the face of the human subject is identified as shown in FIG. 4. The plurality of feature portions preferably comprises the eyes, the mouth and the nose of the face of the human subject. In addition, the plurality of feature portions is identified by locating the face of the human subject in the 2D image 100. The face of the human subject is locatable in the 2D image 100 using methods well known in the art such as knowledge-based methods, feature invariant approaches, template matching methods and appearance-based methods. After the face is located in the 2D image 100, a region 402 of the face is next identified in order to locate important facial features of the human subject. Notably, the facial features correspond to the plurality of feature portions. The identified facial features contained in the region 402 are then detected using edge detection techniques well known in the art.

The identified plurality of feature portions is then marked with a plurality of image reference points 404 using a feature extractor as shown in FIG. 4. Specifically, each of the plurality of image reference points 404 has 3D coordinates. In order to obtain substantially accurate 3D coordinates of each of the plurality of image reference points 404, the feature extractor requires prior training in which the feature extractor is taught how to identify and mark image reference points using training images that are manually labelled and are normalized at a fixed ocular distance. For example, by using an image in which there is a plurality of image feature points, each image feature point (x, y) is first extracted using multi-resolution 2D gabor wavelets that are taken in eight different scale resolution and from six different orientations to thereby produce a forty-eight dimensional feature vector.

Next, in order to improve the extraction resolution of the feature extractor around an image feature point (x, y), counter solutions around the region of the image feature point (x, y) are collected and the feature extractor is trained to reject the counter solutions. All extracted feature vectors (also known as positive samples) of a image feature point are then stored in a stack “A” while the feature vectors of counter solutions (also known as negative samples) are then stored in a corresponding stack “B”. This then produces a forty-eight dimensional feature vector and dimensionality reduction using principal component analysis (PCA) is then required. Thus, dimensionality reduction is performed for both the positive samples (PCA_A) and the negative samples (PCA_B).

The separability between the positive samples and the negative samples is optimized using linear discriminant analysis (LDA). The LDA computation of the positive samples is performed using the positive samples and negative samples as training sets. Two different sets, PCA_A(A) and PCA_A(B), are then created from the projection of the positive samples. The set PCA_A(A) is assigned as class “0” and the set PCA_A(B) is assigned as class “1”. The best linear discriminant is then defined using the fisher linear discriminant analysis on the basis of a two-class problem. The linear discriminant analysis of the set PCA_A(A) is obtained by computing LDA_A(PCA_A(A)) since a “0” value must be generated. Similarly, the linear discriminant analysis of the set PCA_A(B) is obtained by computing LDA_A(PCA_A(B)) since a “1” value must be generated. The separability threshold present between the two classes is then estimated.

Separately, LDA_B undergoes the same process as explained afore for LDA_A. However, instead of using the sets, PCA_A(A) and PCA_A(B), the sets PCA_B(A) and PCA_B(B) are used. Two scores are then obtained by subjecting an unknown feature vector, X, through the following two processes:

X [symbol] PCA_A [symbol] LDA_A (1)

X [symbol] PCA_B [symbol] LDA_B (2)

The feature vector, X, is preferably accepted by the process LDA_A(PCA_A(X)) and is preferably rejected by the process LDA_B(PCA_B(X)). The proposition is that two discriminant functions are defined for each class using a decision rule being based on the statistical distribution of the projected data:

f(x)=LDA_{—}A(PCA_{—}A(x)) (3)

g(x)=LDA_{—}B(PCA_{—}B(x)) (4)

Set “A” and set “B” are defined as the “feature” and “non-feature” training sets respectively. Further, four one-dimensional clusters are also defined: GA=g(A), FB=f(B), FA=f(A) and GB=f(b). The derivation of the mean, x̅, and standard deviation, σ, of each of the four one-dimensional clusters, FA, FB, GA and GB, are then computed. The mean and standard deviation of FA, FB, GA and GB are respectively expressed as ( x̅_{FA},σ_{FA}), ( x̅_{FB},σ_{FB}), ( x̅_{GA},σ_{GA}) and ( x̅_{GB},σ_{FB}).

Additionally, for a given vector Y, the projections of the vector Y using the two discriminant functions are obtained:

yf=f(Y) (5)

yg=g(Y) (6)

Further, let

$$yfa = \frac{\vert yf - mFA \vert}{sFA} , yfb = \frac{\vert yf - mFB \vert}{sFB} , \\ yga = \frac{\vert yf - mGA \vert}{sGA} and ygb = \frac{\vert yf - mGB \vert}{sGB} .$$

The vector Y is then classified as class “A” or “B” according to the pseudo-code, which is expressed as:
if(min(yfa, yga)<min(yfb, ygb)) then
   label=A; else
   label=B;
   RA=RB=0;
if(yfa>3.09)or(yga>3.09) RA=1;
if(yfb>3.09)or(ygb>3.09) RB=1;
if(RA=1)or(RB=1) label=B;
if(RA=1)or(RB=0) label=B;
if(RA=0)or(RB=1) label=A;

Preferably, the plurality of image reference points 404 in 3D are correlated with and estimated from the feature portions of the face in 2D space by a pre-determined function. In addition, as shown in FIG. 4, the plurality of image reference points 404 being marked on the 2D image 100 are preferably the left and right eyes center, nose tip, the left and right nose lobes, the left and upper contours, the left and right lower contours, the left and right lip ends and the chin tip contour.

The head pose of the human subject in the 2D image 100 is estimated prior to deformation of the 3D mesh 200. First, the 3D mesh 200 is rotated at an azimuth angle, and edges are extracted using an edge detection algorithm such as the Canny edge detector. 3D mesh-edge maps are then computed for the 3D mesh 200 for azimuth angles ranging from −90 degrees to +90 degrees, in increments of 5 degrees. Preferably, the 3D mesh-edge maps are computed only once and stored off-line in an image array.

To estimate the head pose in the 2D image 100, the edges of the 2D image 100 are extracted using the edge detection algorithm to obtain an image edge map (not shown) of the 2D image 100. Each of the 3D mesh-edge maps is compared to the image edge map to determine which pose results in the best overlap of the 3D mesh-edge maps. To compute the disparity between the 3D mesh-edge maps, the Euclidean distance-transform (DT) of the image edge map is computed. For each pixel in the image edge map, the DT process assigns a number that represents the distance between that pixel and the nearest non-zero pixel of the image edge map.

The value of the cost function, F, of each of the 3D mesh-edge maps is then computed. The cost function, F, which measures the disparity between the 3D mesh-edge maps and the image edge map is expressed as:

$$F = \frac{{\sum }_{( i , j ) ∈ {A}_{EM}} DT ( i , j )}{N} \qquad ( 7 )$$

where A_{EM}≅{(i, j):EM(i, j)=1} and N is the cardinality of set A_{EM} (total number of nonzero pixels in the 3D mesh-edge map EM). F is the average distance-transform value at the nonzero pixels of the image edge map. The pose for which the corresponding 3D mesh-edge map results in the lowest value of F is the estimated head-pose for the 2D image 100.

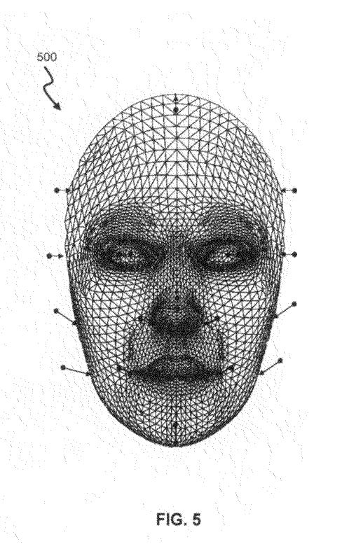

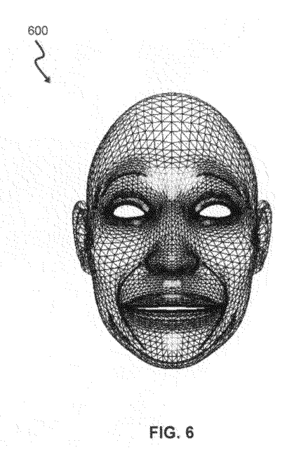

Once the pose of the human subject in the 2D image 100 is known, the 3D mesh 200 undergoes global deformation for spatially and dimensionally registering the 3D mesh 200 to the 2D image 100. The deformation of the 3D mesh 200 is shown in FIG. 5. Typically, an affine deformation model for the global deformation of the 3D mesh 200 is used and the plurality of image reference points is used to determine a solution for the affine parameters. A typical affine model used for the global deformation is expressed as:

$$[ \begin{matrix}{X}_{gb} \\ {Y}_{gb} \\ {Z}_{gb}\end{matrix} ] = [ \begin{matrix}{a}_{11} & {a}_{12} & 0 \\ {a}_{21} & {a}_{22} & 0 \\ 0 & 0 & \frac{1}{2} {a}_{11} + \frac{1}{2} {a}_{22}\end{matrix} ] [ \begin{matrix}X \\ Y \\ Z\end{matrix} ] + [ \begin{matrix}{b}_{1} \\ {b}_{2} \\ 0\end{matrix} ] \qquad ( 8 )$$

where (X, Y, Z) are the 3D coordinates of the vertices of the 3D mesh 200, and subscript “gb” denotes global deformation. The affine model appropriately stretches or shrinks the 3D mesh 200 along the X and Y axes and also takes into account the shearing occurring in the X-Y plane. The affine deformation parameters are obtained by minimizing the re-projection error of the first plurality of mesh reference points on the rotated deformed 3D mesh 200 and the corresponding 2D locations in the 2D image 100. The 2D projection (x_{f}, y_{f}) of the 3D feature points (X_{f}, Y_{f}, Z_{f}) on the deformed 3D mesh 200 is expressed as:

$$[ \begin{matrix}{x}_{f} \\ {y}_{f}\end{matrix} ] = \underbrace{[ \begin{matrix}{r}_{11} & {r}_{12} & {r}_{13} \\ {r}_{21} & {r}_{22} & {r}_{23}\end{matrix} ]}_{{R}_{12}} [ \begin{matrix}{a}_{11} {X}_{f} + {a}_{12} {Y}_{f} + {b}_{1} \\ {a}_{12} {X}_{f} + {a}_{22} {Y}_{f} + {b}_{2} \\ \frac{1}{2} ( {a}_{11} + {a}_{22} ) {Z}_{f}\end{matrix} ] \qquad ( 9 )$$

where R₁₂ is the matrix containing the top two rows of the rotation matrix corresponding to the estimated head pose for the 2D image 100. By using the 3D coordinates of the plurality of image reference points, equation (9) can then be reformulated into a linear system of equations. The affine deformation parameters P=[a₁₁, a₁₂, a₂₁, a₂₂, b₁, b₂]^{T} are then determinable by obtaining a least-squares (LS) solution of the linear system of equations. The 3D mesh 200 is globally deformed according to these parameters, thus ensuring that the 3D head object 600 created conforms with the approximate shape of the face of the human subject and the significant features are properly aligned. The 3D head object 600 is shown in FIG. 6. In addition, to more accurately adapt the 3D mesh 200 to the human subject's face from the 2D image 100, local deformations are introducible in the globally deformed 3D mesh 200. Local deformations of the 3D mesh 200 is performed via displacement of the second plurality of mesh reference points towards corresponding portions of the plurality of the image reference points 404 in 3D space. Displacements of the second plurality of mesh reference points are perturbated to the vertices extending therebetween on the 3D mesh 200. The perturbated displacements of the vertices are preferably estimated using a radial basis function.

Once the 3D mesh 200 is adapted and deformed according to the 2D image 100, the texture of the human subject is extracted and mapped onto the 3D head object 600 for visualization. The 3D head object 600 with texture mapping being applied onto is then an approximate representation of the head object of the human subject in the 2D image 100. Lastly, a series of synthesized 2D images of the 3D head object 600 in various predefined orientations and poses in 3D space are captured for creating a database of synthesized 2D images 100 of the human subject. In addition, the 3D head object 600 is further manipulated such as viewing the 3D head object 600 in simulated lighting conditions with respect to different angles. The database then provides the basis for performing face recognition of the human subject under any conceivable conditions. Face recognition is typically performed within acceptable error tolerances of a face recognition system.

In the foregoing manner, a method for synthesizing a plurality of 2D face images of an image object based on a synthesized 3D head object of the image object is described according to embodiments of the invention for addressing at least one of the foregoing disadvantages. Although a few embodiments of the invention are disclosed, it will be apparent to one skilled in the art in view of this disclosure that numerous changes and/or modification can be made without departing from the spirit and scope of the invention.

1. A method for synthesizing a representation of an image object, the method comprising:
providing an image of the image object, the image being a two-dimensional (2D) representation of the image object;
providing a three-dimensional (3D) mesh having a plurality of mesh reference points, the plurality of mesh reference points being predefined;
identifying a plurality of feature portions of the image object from the image;
identifying a plurality of image reference points based on the plurality of feature portions of the image object, the plurality of image reference points having 3D coordinates;
at least one of manipulating and deforming the 3D mesh by compensating the plurality of mesh reference points accordingly towards the plurality of image reference points; and
mapping the image object onto the deformed 3D mesh to obtain a head object, the head object being a 3D object,
wherein a synthesized image of the image object in at least one of an orientation and a position is obtainable from the head object positioned to the at least one of the orientation and the position.

2. The method as in claim 1, further comprising:
capturing the synthesized image of the head object in at least one of the orientation and the position, the synthesized image being a 2D image.

3. The method as in claim 1, further comprising:
manipulating the head object for capturing a plurality of synthesized images,
wherein each of the plurality of synthesized face images is a 2D image.

4. The method as in claim 1, wherein the 3D mesh is a reference 3D mesh representation of the face of a person.

5. The method as in claim 1, wherein the image object is the face of a person.

6. The method as in claim 5, wherein the plurality of feature portions of the face is at least one of the eyes, the nostrils, the nose and the mouth of the person.

7. The method as in claim 1, wherein properties of the feature portions of the image object in the image is identified using principal components analysis (PCA).

8. The method as in claim 1, wherein providing the image of the image object comprises acquiring the image of the image object using an image capture device.

9. The method as in claim 8, wherein the image capture device is one of a charge-coupled device (CCD) and a complementary metal-oxide-semiconductor (CMOS) sensor.

10. The method as in claim 1, wherein identifying the plurality of feature portions comprises:
identifying the plurality of feature portions of the image object by edge detection.

11. The method as in claim 2, wherein capturing the synthesized image of the head object in at least one of the orientation and the position comprises:
at least one of displacing the head object to the at least one of the orientation and the position; and
capturing the displaced head object to thereby obtain the synthesized image therefrom.

12. A device readable medium having stored therein a plurality of programming instructions, which when execute by a machine, the instructions cause the machine to:
provide an image of the image object, the image being a two-dimensional (2D) representation of the image object;
provide a three-dimensional (3D) mesh having a plurality of mesh reference points, the plurality of mesh reference points being predefined;
identify a plurality of feature portions of the image object from the image;
identify a plurality of image reference points based on the plurality of feature portions of the image object, the plurality of image reference points having 3D coordinates;
at least one of manipulate and deform the 3D mesh by compensating the plurality of mesh reference points accordingly towards the plurality of image reference points; and
map the image object onto the deformed 3D mesh to obtain a head object, the head object being a 3D object,
wherein a synthesized image of the image object in at least one of an orientation and a position is obtainable from the head object positioned to the at least one of the orientation and the position.

13. The device readable medium as in claim 12, wherein the programming instructions, which when executed by a machine, cause the machine to further capture the synthesized image of the head object in at least one of the orientation and the position, the synthesized image being a 2D image.

14. The device readable medium as in claim 12, wherein the programming instructions, which when executed by a machine, cause the machine to further manipulate the head object for capturing a plurality of synthesized images, each of the plurality of synthesized face images being a 2D image.

15. The device readable medium as in claim 12, wherein the 3D mesh is a reference 3D mesh representation of the face of a person.

16. The device readable medium as in claim 12, wherein the image object is the face of a person.

17. The device readable medium as in claim 16, wherein the plurality of feature portions of the face is at least one of the eyes, the nostrils, the nose and the mouth of the person.

18. The device readable medium as in claim 12, wherein the programming instructions, which when executed by a machine, cause the machine to:
identify properties of the feature portions of the image object in the image using principal components analysis (PCA).

19. The device readable medium as in claim 12, wherein the image of the image object is provided by acquiring the image of the image object using an image capture device.

20. The device readable medium as in claim 19, wherein image capture device is one of a charge-coupled device (CCD) and a complementary metal-oxide-semiconductor (CMOS) sensor.

21. The device readable medium as in claim 12, wherein the programming instructions, which when executed by a machine, cause the machine to:
identify the plurality of feature portions of the image object by edge detection.

22. The device readable medium as in claim 13, wherein the programming instructions, which when executed by a machine, cause the machine to:
at least one of displace the head object to the at least one of the orientation and the position; and
capture the displaced head object to thereby obtain the synthesized image therefrom.
